(19) United States
(12) Patent Application Publication
(10) Pub. No.: US 2006/0146541 A1
(43) Pub. Date: Jul. 6, 2006

(54) Lamp comprising an envelope part and a cap part

(76) Inventor: Johannes Antonius Adrianus Maria Van Heeswijk, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/560,640

(22) PCT Filed: Jun. 10, 2004
(86) PCT No.: PCT/IB04/50883

§ 371 Date: Dec. 13, 2005

(30) Foreign Application Priority Data
Jun. 17, 2003 (EP) 03101765.0

(51) Int. Cl. F21V 15/00

(52) U.S. Cl. 362/362

(57) ABSTRACT

A lamp comprising an envelope part (1) and a cap part (2). The envelope part (1) has a pinch part (4) provided with two parallel lead-in conductor wires (10) extending outwards beyond said pinch portion (4). The cap part (2) has two contact members (5) for contacting corresponding electrical contacts of a lampholder. Each conductor wire (10) is connected to a corresponding contact member (5) of the cap part (2). Two flat surfaces (14) are present at both sides of the pinch part (4), said surfaces (14) being parallel to the plane through said conductor wires (10). Clamping elements (8) of the cap part (2) about against said surfaces (14) to provide a fixation of the envelope part (1) relative to the cap part (2).

The invention relates to a lamp comprising an envelope part and a cap part, the envelope part having a pinch portion provided with two parallel lead-in conductor wires extending outwards beyond said pinch portion, the cap part having two contact members for contacting corresponding electrical contacts of a lampholder, each conductor wire being connected to a corresponding contact member of the cap part.

The lamp may be a filament lamp such as a halogen lamp or any other type of lamp comprising an envelope part and a cap part. Apart from the two lead-in conductor wires, there may be a third lead-in conductor wire and a corresponding third contact member, as is the case with certain types of lamps.

The envelope of a lamp may be made of quartz glass or another transparent material and envelops the light-emitting element or elements of the lamp. Two (or more) conductor wires for transporting electrical power to said light-emitting element are embedded in the pinch portion of the envelope and extend outside said pinch portion. The cap part of the lamp is mainly made of insulating material, for example ceramic material, and is provided with metal contact members to which the conductor wires are connected by a soldering or welding operation.

An adequate fixation between the envelope part and the cap part of the lamp may be achieved in various manners. For many applications, notably if the emitted light is reflected by a reflector, a correct positioning of the envelope part with respect to the cap part is important. In any case the fixation must be reliable.

A usual way of fixation of the envelope part of a lamp relative to the cap part of a lamp is the application of cement as a bonding material. However, cement has some disadvantages such as vulnerability to moisture and it is not very constant in quality. Furthermore, cement causes contamination in lamp manufacture.

The object of the invention is to provide a reliable and simple fixation between the envelope part and the cap part of a lamp.

In order to accomplish this objective, flat surfaces are present at both sides of the pinch portion, said surfaces being parallel to the plane through said conductor wires, and clamping elements of the cap part abut against said surfaces. The envelope part is thus fixed in its position relative to the cap part by the conductor wires on the one hand and by the clamping elements on the other hand. In practice this combination of fixation means has proved to be effective.

In one preferred embodiment, the two contact members of the cap part are outwardly extending tubular members, i.e. hollow pins, through which the conductor wires extend. Each conductor wire may be soldered or welded to the corresponding tubular member at the end of the tubular member.

Preferably, the pinch part has an I-shaped cross-section, and the flat surfaces are located in the central part of said I-shape. Such a cross-section provides a solid and rigid pinch portion that is suited for carrying the remainder of the envelope part of the lamp.

In one preferred embodiment, the clamping elements are metal spring elements which can be affixed to the cap part of the lamp. When the spring elements are applied, they will undergo an elastic deformation, so that the pinch of the envelope part is clamped between the spring elements by spring force.

Preferably, the metal spring elements can be applied when the envelope part and the cap part are fixed in a predetermined position relative to each other, owing to which the spring elements undergo a plastic deformation. The plastic deformation ensures that the spring elements push against the flat surface of the pinch part with a predetermined force, independent of the position of the pinch portion relative to the cap part.

In one preferred embodiment, the clamping element is a metal strip-like part surrounding a protrusion of the cap part, such that it is fixed to said protrusion and a portion of the strip is located at a distance from the protrusion, which portion abuts against said flat surface of the pinch portion of the envelope part. Said portion of the strip may be curved into an outwardly extending loop.

The invention furthermore relates to a method of manufacturing a lamp, whereby an envelope part is connected to a cap part, the envelope part having a pinch portion provided with two parallel lead-in conductor wires extending outwardly beyond said pinch portion, and the cap part having two contact members for contacting corresponding electrical contacts of a lampholder, each conductor wire being connected to a corresponding contact member of the cap part, wherein, when the envelope part and the cap part are kept in a predetermined position relative to each other, the conductor wires are soldered or welded to the contact members, and clamping elements are attached to the cap part, which clamping elements abut against flat surfaces present at both sides of the pinch portion, said surfaces being parallel to the plane through said conductor wires.

The invention will now be explained by means of a description of an embodiment of a lamp, reference being made to a drawing, in which:

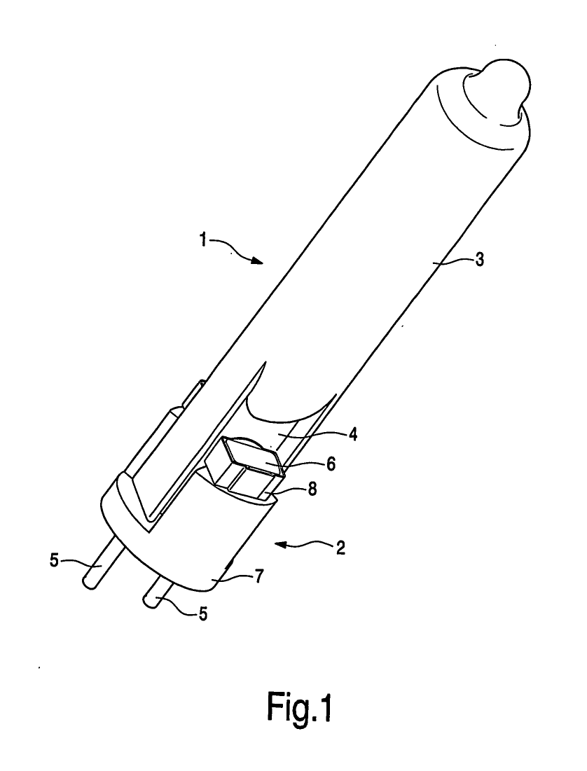

FIG. 1 is a perspective view of the embodiment;

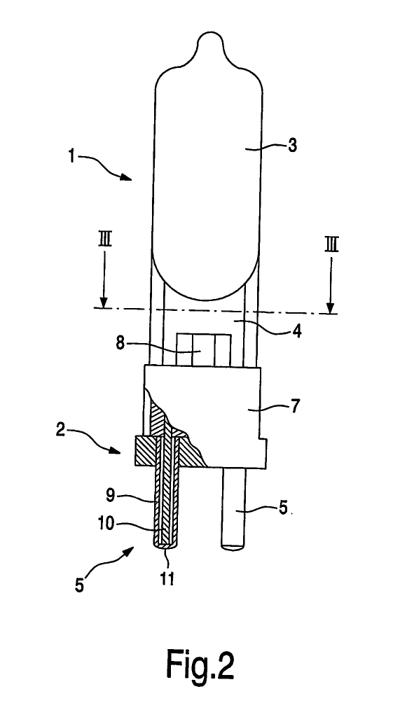

FIG. 2 is a side view of the embodiment;

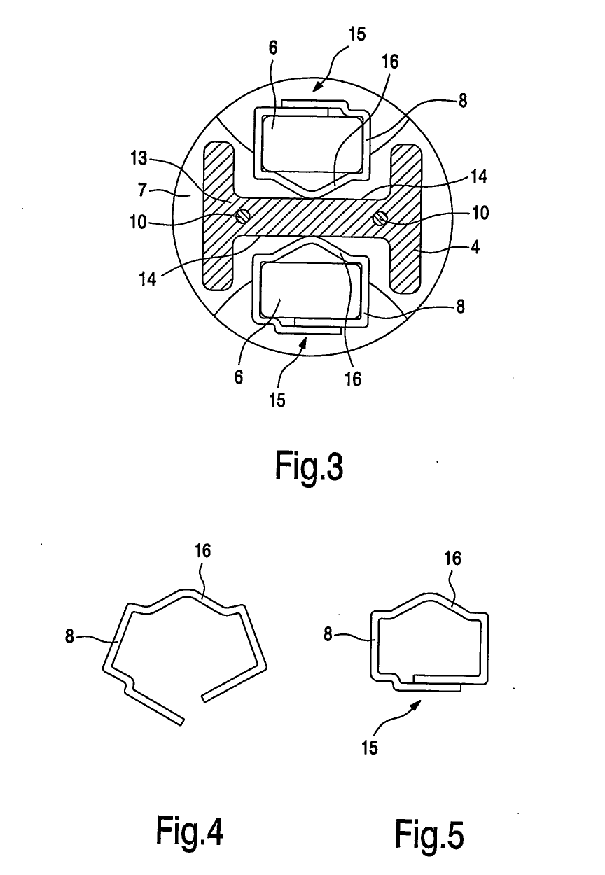

FIG. 3 is a sectional view taken on the line III-III in FIG. 2; and

FIGS. 4 and 5 are views of a clamping element;

which Figs. are merely schematic representations of the embodiment

FIG. 1 shows the lamp comprising an envelope part 1 and a cap part 2. The envelope part 1 is made of quartz glass and comprises a transparent envelope 3 envelopping the light-emitting element of the lamp. The envelope part 1 furthermore comprises a pinch portion 4 having an I-shaped cross-section and being engaged by the cap part 2 of the lamp.

The cap part 2 is mainly made of ceramic material and comprises two metal contact members 5, each being a hollow metal pin. These contact members 5 contact corresponding contacts of a lampholder when the lamp is fitted in that lampholder. The cap part 2 furthermore comprises two protrusions 6 located at both sides of the pinch portion 4 and extending from the main body 7 of the cap part 2. In FIG. 1 only one protrusion 6 is visible. Each protrusion 6 is surrounded by a metal clamping element 8. The two clamping elements 8 abut against flat surfaces at both sides of the pinch portion 4, thus clamping the pinch portion 4.

FIG. 2 is a side view of the lamp in which a portion of the cap part 2 is removed to show one contact member 5 in a sectional view. The sectional view shows the cap part 2 in the plane through the two contact members 5.

The contact member 5 consists of a metal hollow tube 9 which is fixed in a bore in the main body 7 of the cap part 2. As shown in the sectional part of FIG. 2, the lead-in conductor wire 10 is embedded in the pinch portion 4 of the envelope part 1. The part of conductor wire 10 extending outside said pinch portion 4 is located inside the tube 9. The conductor wire 10 is soldered or welded to the tube 9 at the end 11 of said tube 9, which connection forms part of the fixation means between the envelope part 1 and the cap part 2 of the lamp. The two clamping elements 8 from the other part of said fixation means. FIG. 2 shows only one clamping element 8, but FIG. 3 shows both clamping elements 8.

FIG. 3 is a sectional view, as indicated in FIG. 2, showing the pinch portion 4 of the envelope part 1 in cross-section and showing the cap part 2 in plan view. Pinch portion 4 has an I-shaped cross-section and surrounds the two lead-in conductor wires 10. The central portion 13 of the I-shape is provided with a flat surface 14 at both sides.

As shown in FIG. 3, each clamping element 8 surrounds a protrusion 6 of the cap part 2. Clamping element 8 is a metal strip-like part, and the ends of the strip are welded together, indicated with 15. Another portion of the strip is curved such that it forms a loop 16 at a distance from the surface of the protrusion 6. The loops 16 of the two clamping elements 8 abut against the flat surfaces 14 at both sides of the pinch portion 4, so that the pinch portion 4 is clamped between the loops 16. This camping action in combination with the connection through the two conductor wires 10 achieves an effective fixation of the envelope part 1 to the cap part 2 of the lamp.

FIG. 4 shows the clamping element 8 before it is attached to the cap part 2 of the lamp, and FIG. 5 shows the clamping element 8 after it has been attached. The clamping element 8 is applied as follows. In the shape as shown in FIG. 4, the clamping element 8 is placed around protrusion 6 of the cap part 2. Then the clamping element 8 is brought into the shape as shown in FIG. 5. As a result it clamps around protrusion 6 so that it is fixed to the protrusion 6. Furthermore, the loop 16 moves further outward, i.e. away from the protrusion 6, so that it abuts against the surface 14 of pinch portion 4, whereby the metal material of the loop 16 will be deformed, resulting in a substantial compression force between the clamping element 8 and the surface 14. The clamping element 8 thus functions as a spring element. Preferably, the deformation of loop 16 is not limited to elastic deformation, but also involves plastic deformation. Such a plastic deformation ensures that the maximum compression force is present and furthermore that the compression forces are equal at both sides of the pinch part 4.

After the clamping element 8 has been brought to its final shape as shown in FIG. 5, its ends are welded together by a spotwelding operation as indicated with 15.

The embodiment of the lamp described is merely an example; a great many other embodiments are possible, including other kinds of lamps.

1. A lamp comprising an envelope part and a cap part, the envelope part having a pinch portion provided with two parallel lead-in conductor wires extending outwards beyond said pinch portion, the cap part having two contact members for contacting corresponding electrical contacts of a lampholder, each conductor wire being connected to a corresponding contact member of the cap part, characterized in that two flat surfaces are present at both sides of the pinch portion, said surfaces being parallel to the plane through said conductor wires, and in that clamping elements of the cap part abut against said surfaces.

2. A lamp as claimed in claim 1, characterized in that the two contact members of the cap part are outwardly extending tubular members.

3. A lamp as claimed in claim 1, characterized in that the pinch portion has an I-shaped cross-section, and in that the flat surfaces are located in the central portion of said I-shape.

4. A lamp as claimed in claim 1, characterized in that the clamping elements are metal spring elements.

5. A lamp as claimed in claim 4, characterized in that the metal spring elements are applied when the envelope part and the cap part are fixed in a predetermined position relative to each other, owing to which the spring elements undergo a plastic deformation.

6. A lamp as claimed in claim 1, characterized in that the clamping element is a metal strip-like part surrounding a protrusion of the cap part such that it is fixed to said protrusion, and a portion of the strip is located at a distance from the protrusion, which portion abuts against said flat surface of the pinch portion of the envelope part.

7. A method of manufacturing a lamp whereby an envelope part is connected to a cap part, the envelope part having a pinch portion provided with two parallel lead-in conductor wires extending outwards beyond said pinch portion, and the cap part having two contact members for contacting corresponding electrical contacts of a lampholder, each conductor wire being connected to a corresponding contact member of the cap part, characterized in that, when the envelope part and the cap part are fixed in a predetermined position relative to each other, the conductor wires are soldered or welded to the contact members, and two clamping elements are attached to the cap part, which two clamping elements abut against two flat surfaces present at both sides of the pinch portion, said surfaces being parallel to the plane through said conductor wires.

8. A method as claimed in claim 7, characterized in that the clamping elements are metal spring elements, and in that the metal spring elements undergo a plastic deformation when they are attached to the cap part of the lamp.

9. A method as claimed in claim 7, characterized in that the clamping element is a metal strip-like part and the ends of said strip-like part are welded together when the strip-like part surrounds a protrusion of the cap part, so that it is fixed to said protrusion, while a portion of the strip is located at a distance from the protrusion, which portion abuts against said flat surface of the pinch portion of the envelope part.
